(19) United States
(12) Patent Application Publication
(10) Pub. No.: US 2026/0290025 A1
(43) Pub. Date: Sep. 24, 2026

(54) Multi-Lens Ground-To-Air Aerial Object Detection

(71) Applicant: Narsll Dynamics, Las Vegas, NV (US)

(72) Inventors: Meng-Liang Chen, Las Vegas, NV (US); Shanyao Lee, Las Vegas, NV (US)

(73) Assignee: Narsil Dynamics, Las Vegas, NV (US)

(21) Appl. No.: 19/575,853

(22) Filed: Mar. 23, 2026

Related U.S. Application Data
(60) Provisional application No. 63/776,225, filed on Mar. 23, 2025.

(51) Int. Cl. G06V 20/52; G06V 10/10; G06V 10/70; G06V 20/40; H04N 23/68; H04N 23/90

(52) U.S. Cl. CPC G06V 20/52; G06V 10/17; G06V 10/70; G06V 20/40; H04N 23/68; H04N 23/90

(57) ABSTRACT

An apparatus of multi-lens ground-to-air aerial object detection includes a multi-camera system and a multi-axis gimbal system on which the multi-camera system is mounted. The multi-camera system is configured to capture images across a range of altitudes. The multi-camera system includes different imaging devices with different lenses of different fields of view (FOVs). The different FOVs correspond to different observation distance ranges. The different imaging devices provide different target pixel densities at different distances. At the different distances, at least one of the different imaging devices maintains a target representation above a minimum resolution threshold.

### CROSS-REFERENCE TO RELATED PATENT APPLICATIONS

The present disclosure is part of a non-provisional application claiming the priority benefit of U.S. Patent Application 63/776,225, filed 23 Mar. 2025, the content of which being incorporated by reference in its entirety.

### TECHNICAL FIELD

The present disclosure is generally related to aerial object detection and, more particularly, to methods and apparatus of multi-lens ground-to-air aerial object detection.

### BACKGROUND

Unless otherwise indicated herein, approaches described in this section are not prior art to the claims listed below and are not admitted as prior art by inclusion in this section.

In modern battlefields, the ever growing presence of small and low-altitude unmanned aerial vehicles (UAVs), such as drones, presents a significant challenge. Traditional radar systems, though effective, tend to be costly and impractical in portable applications, e.g., for soldiers to carry, due to the size and weight of a typical radar system. Thus, there exists an issue of providing and equipping soldiers and combat personnel with a lightweight or otherwise portable means of ground-to-air aerial object detection. Therefore, there is a need for a solution for multi-lens ground-to-air aerial object detection.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In view of the aforementioned issues, an objective of the present disclosure is to propose designs of a portable drone detector that leverages advanced optical and computational technologies. It is believed that the proposed designs can address or otherwise alleviate the aforementioned issue.

In one aspect, an apparatus of multi-lens ground-to-air aerial object detection may include a multi-camera system and a multi-axis gimbal system on which the multi-camera system is mounted. The multi-camera system may be configured to capture images across a range of altitudes. The multi-camera system may include different imaging devices with different lenses of different fields of view (FOVs). The different FOVs correspond to different observation distance ranges. The different imaging devices provide different target pixel densities at different distances. At the different distances, at least one of the different imaging devices maintains a target representation above a minimum resolution threshold.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example multi-camera system under a proposed scheme in accordance with the present disclosure.

FIG. 2 is a diagram of an example apparatus under a proposed scheme in accordance with the present disclosure.

FIG. 3 is a diagram of an example scenario under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word "proximal" means closer to the reference point, in this case, the shooter. As used herein, the word "distal" means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

Under the various proposed schemes in accordance with the present disclosure, an apparatus of multi-lens ground-to-air aerial object detection may utilize different imaging devices (e.g., cameras) having lenses with distinct view angles – for instance, a 70-degree lens for low-altitude coverage and a 26-degree lens for high-altitude surveillance – to comprehensively monitor the sky. These lenses may be mounted on one or more gimbal stabilizers, which ensure the imaging devices remain oriented toward the sky, thereby compensating for a soldier’s movements (e.g., as the soldier moves about while carrying the apparatus). High-quality complementary metal-oxide-semiconductor (CMOS) image sensors may be utilized in the imaging devices to capture continuous video footage, which may be processed by an integrated artificial intelligence (AI) system. The AI system may analyze the video footage in real-time to detect and identify UAVs/drones and, upon detection, alert the user instantly.

Those of ordinary skill in the art may appreciate the key advantages provided by the apparatus of multi-lens ground-to-air aerial object detection under the proposed schemes in accordance with the present disclosure. For instance, the apparatus is lightweight and portable, thus it may be conveniently carried by individual solders. Compared to conventional radar systems, the apparatus of multi-lens ground-to-air aerial object detection under the proposed schemes is much more cost-effective and optimized for detecting small UAVs/drones at varying altitudes. Unlike approaches that rely on a single camera or alternative sensors, the multi-lens design under the proposed schemes may enhance coverage and performance. For example, a soldier on patrol may mount the apparatus on his/her gear, thereby enabling continuous sky scanning and immediate alerts of detection of UAVs/drones. In other words, the apparatus under the proposed schemes may significantly boost battlefield awareness and security.

### Illustrative Implementations

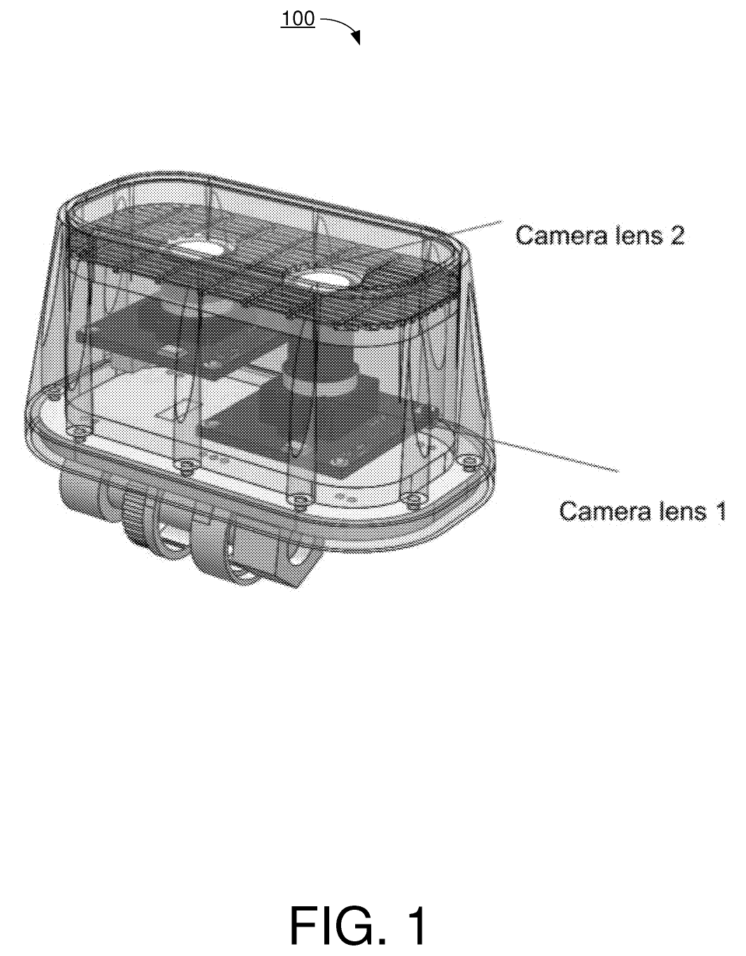

FIG. 1 illustrates an example multi-camera system 100 under a proposed scheme in accordance with the present disclosure. Multi-camera system 100 may be designed to optimize image capture across a range of altitudes to ensure the best possible resolution on the CMOS sensor(s) by utilizing lenses with different view angles, which may be specifically tailored to the altitudes of the observed subjects. The CMOS sensor(s), known for high image quality and low power consumption, may serve as the foundation for capturing detailed imagery. Moreover, the strategic use of various fields of view (FOVs) may enhance the effectiveness of the CMOS sensor(s). The different imaging devices of multi-camera system 100 may include: (1) one or more imaging devices of narrower view angles for higher altitudes, and (2) one or more imaging devices of wider view angles for lower altitudes.

With respect to narrower view angles for higher altitudes, one or more imaging devices of multi-camera system 100 for narrower view angles for higher altitudes equipped with narrower FOVs may be configured to cover higher altitudes. At higher altitudes/heights, subjects of interest—whether objects in the sky or on the ground—may be farther from the camera(s). A narrower FOV, achieved with a longer focal length lens, may magnify the scene and focus on a smaller area to project finer details onto the CMOS sensor(s). This approach may increase the pixel density per subject area, resulting in higher resolution images of distant subjects (e.g., targets). For example, when observing high-altitude phenomena from a ground-based platform or capturing detailed ground imagery from an elevated aircraft, the narrow FOV may ensure clarity despite of an increased distance.

With respect to wider view angles for lower altitudes, one or more imaging devices of multi-camera system 100 for wider view angles for higher altitudes equipped with wider FOVs may be configured to cover lower altitudes. At lower altitudes/heights, subjects of interest may be closer to the camera(s). A wider FOV, facilitated by a shorter focal length lens, may capture an image of a broader area without requiring excessive magnification. This may be ideal for scenarios where the camera is nearer to the subject (e.g., target), such as low-altitude aerial surveillance or sky observation closer to the horizon. By encompassing more of the scene, the wider FOV may ensure comprehensive coverage while still maintaining sufficient detail on the CMOS sensor(s), effectively leveraging the high resolution capabilities.

This multi-camera configuration, with each lens tailored to a specific angle, may allow multi-camera system 100 to dynamically adapt to different observational needs. By matching the field of view to the altitude, multi-camera system 100 may maximize image resolution across diverse conditions—whether scanning the sky for high-altitude objects or capturing expansive views at lower heights. The integration of different imaging devices, each with a distinct FOV, may ensure delivery of optimal image quality by the CMOS sensor(s), thereby rendering multi-camera system 100 versatile and highly effective for applications requiring maximum aerial field coverage.

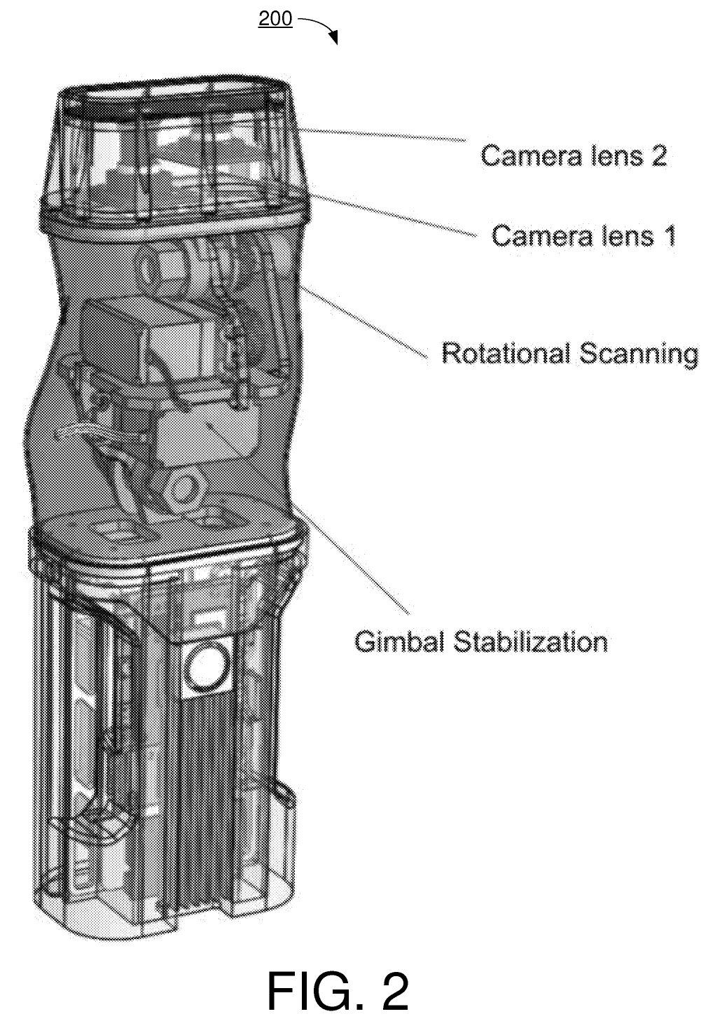

FIG. 2 illustrates an example apparatus 200 under a proposed scheme in accordance with the present disclosure. Apparatus 200 may be a detector of multi-lens ground-to-air aerial object detection and may include multi-camera system 100. Referring to FIG. 2, apparatus 200 may be configured with gimbal stabilization. That is, apparatus 200 may be configured with a multi-axis (e.g., dual-axis) gimbal system designed to stabilize the imaging devices of multi-camera system 100 and maintain their intended orientations. This multi-axis gimbal system for gimbal stabilization may ensure that each camera remains accurately directed towards specific regions of interest in the sky, regardless of external movement or vibrations.

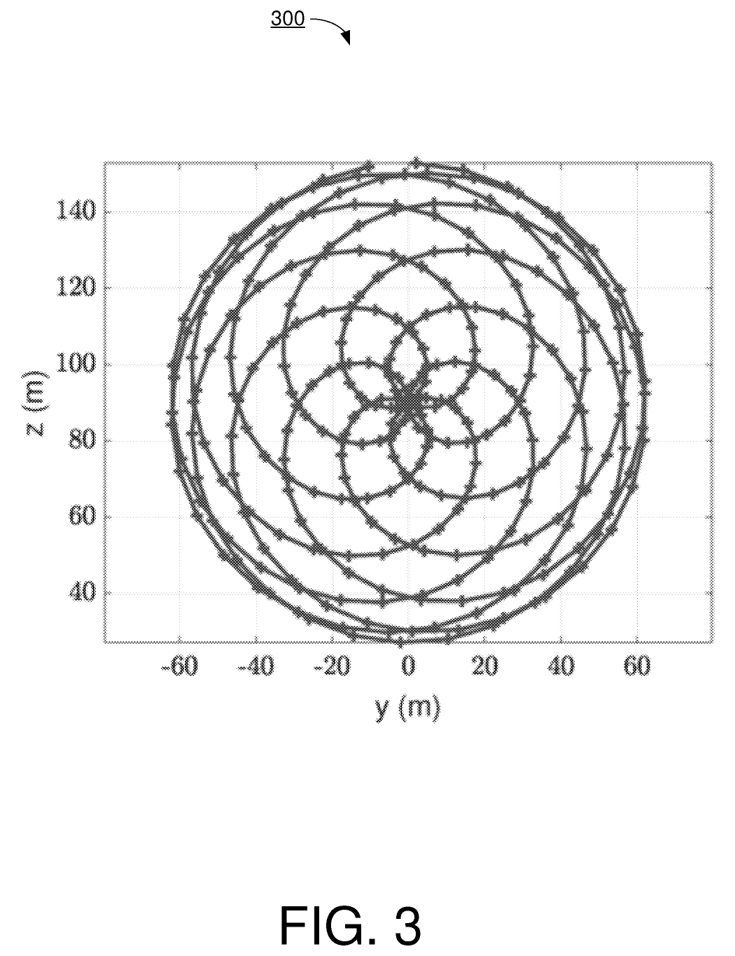

FIG. 3 illustrates an example scenario 300 under a proposed scheme in accordance with the present disclosure. Scenario 300 may pertain to an example scanning pattern by multi-camera system 100 of apparatus 200. Under the proposed scheme, beyond automatically maintaining an upward-facing view, the multi-axis gimbal system of apparatus 200 may also implement a scanning pattern (such as, but not limited to, a rosette scanning pattern as shown in FIG. 3). This design may enable the imaging devices to cover a wider area of the sky, significantly expanding the system’s range of UAV/drone early-warning detection above the user.

With respect to pixel density in the proposed schemes in accordance with the present disclosure, the term “target pixel density” may refer to a number of pixels occupied by a target object in an image or its corresponding pixel resolution. This value may be related to the observation distance, lens FOV, and sensor resolution. As the observation distance increases, the projected size of the target in the image may decrease with distance, leading to a decrease in pixel density, which in turn may affect the target's identification and capability of the apparatus to make determination. By configuring or otherwise equipping the multiple/different imaging devices with different FOVs, the proposed schemes ensure a sufficient pixel density for a given target in at least one of the different imaging devices across different distance ranges, thereby supporting subsequent detection and/or identification needs. In the present disclosure, the pixel density may pertain to, for example and not limited to, one or more of the following: (1) the number of pixels occupied by the target’s width or height in the image; (2) the total number of pixels covered by the target; and/or (3) a combination of the aforementioned indicators/parameters.

With respect to minimum resolution threshold in the proposed schemes in accordance with the present disclosure, the term “minimum resolution threshold” may refer to the lowest pixel representation requirement that a target must meet in a corresponding image of the target in order to enable the system to effectively detect, identify, and/or track the target. For instance, in some embodiments, a target must occupy at least a predetermined number of pixels in the image (e.g., several pixels in width and/or height) to be considered a valid target. When the target is below this minimum resolution threshold, the system may be unable to stably identify or distinguish the target from background noise. Through the configuration of a multi-field-of-view imaging device, the proposed schemes may ensure that at least one imaging device can maintain the target above the minimum resolution threshold at different viewing distances, thereby improving the overall reliability in target/object detection by the apparatus. The resolution threshold may be adjusted according to application requirements and may not be limited to any specific value.

With respect to design purpose, in airborne detection applications, the system/apparatus needs to simultaneously process or otherwise provide a wide airspace coverage and sufficient image resolution for distant targets. However, traditional single-field-of-view imaging systems tend to struggle to meet these requirements simultaneously. Wide-angle (e.g., large FOV) systems, on the one hand, offer a larger coverage area in comparison but tend to lack sufficient image resolution for distant targets. Narrow-angle (e.g., small FOV) systems, on the other hand, offer a higher resolution but tend to have a limited coverage area, rendering target searching difficult. Therefore, the proposed schemes in accordance with the present disclosure utilize multiple imaging devices with different FOVs to maintain appropriate target pixel density across various distances, thus simultaneously addressing both coverage and resolution requirements. It is believed that this design may avoid the trade-off between "wide-area search" and "long-range identification" inherent in traditional systems.

With respect to differences from zoom systems, traditional imaging systems typically use a single lens combined with mechanical or electronic zoom to adjust the FOV to accommodate observation needs at different distances. However, such systems tend to have a number of limitations. For example, traditional imaging systems typically require switching between different field-of-view angles, making it impossible to simultaneously achieve wide-area coverage and high-resolution observation. Additionally, traditional imaging systems tend to use a narrow field of view during the search process may result in target loss. Moreover, the use of mechanical zoom tends to increase system complexity and response delay. In contrast, the proposed schemes in accordance with the present disclosure employ multiple imaging devices with different fixed FOV angles, observing the same spatial domain in parallel. This design allows the system to simultaneously maintain the following: (a) wide-angle imaging providing spatial coverage; and (b) narrow-angle imaging providing high image resolution at long distances. The proposed schemes may also eliminate the need for zooming operations on a single lens. Advantageously, this multi-FOV parallel architecture may continuously maintain an appropriate range of image resolution of a target without switching fields of view, thereby improving system stability and response efficiency.

### Feature Highlight

In view of the above, an apparatus of multi-lens ground-to-air aerial object detection may include a multi-camera system. The multi-camera system is configured to capture images across a range of altitudes. The multi-camera system includes different imaging devices with different lenses of different fields of view (FOVs). different FOVs may correspond to different observation distance ranges. The different imaging devices may provide different target pixel densities at different distances. At the different distances, at least one of the different imaging devices may be configured to maintain a target representation above a minimum resolution threshold.

In some implementations, the multi-camera system may be configured to not rely on mechanical zooming of a single lens to achieve the aforementioned effects.

In some implementations, the multi-camera system may be configured to capture images of narrower view angles for higher altitudes and wider view angles for lower altitudes.

In some implementations, the multi-camera system may include a 70-degree lens configured to provide a low-altitude coverage and a 26-degree lens configured to provide a high-altitude coverage.

In some implementations, the multi-camera system may further include one or more complementary metal-oxide-semiconductor (CMOS) image sensors configured to capture a video footage via the different imaging devices.

In some implementations, the multi-camera system may further include a processor executing an AI system that analysis the video footage in real-time to detect and identify one or more subjects of interest.

In some implementations, the apparatus may also include a multi-axis gimbal system on which the multi-camera system is mounted. The multi-axis gimbal system may be configured to stabilize the different imaging devices and maintain respective orientations of the different imaging devices.

In some implementations, the multi-axis gimbal system may be configured to automatically maintain an upward-facing view for the different imaging devices.

In some implementations, the multi-axis gimbal system may be configured to implement a scanning pattern for the different imaging devices.

In some implementations, the scanning pattern may include a rosette scanning pattern.

In some implementations, the apparatus may be portable and carriable by an individual user. For instance, the apparatus may provide ground-to-air aerial object detection in a battlefield or other scenarios.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or single terms herein, those having skill in the art can translate from the plural to the single and/or from the single to the plural as is appropriate to the context and/or application. The various single/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus of multi-lens ground-to-air aerial object detection, comprising:
a multi-camera system configured to capture images across a range of altitudes,
wherein the multi-camera system comprises different imaging devices with different lenses of different fields of view (FOVs),
wherein the different FOVs correspond to different observation distance ranges,
wherein the different imaging devices provide different target pixel densities at different distances, and
wherein at the different distances, at least one of the different imaging devices maintains a target representation above a minimum resolution threshold.

2. The apparatus of claim 1, wherein the multi-camera system is configured to capture images of narrower view angles for higher altitudes and wider view angles for lower altitudes.

3. The apparatus of claim 2, wherein the multi-camera system comprises a 70-degree lens configured to provide a low-altitude coverage and a 26-degree lens configured to provide a high-altitude coverage.

4. The apparatus of claim 1, wherein the multi-camera system further comprises one or more complementary metal-oxide-semiconductor (CMOS) image sensors configured to capture a video footage via the different imaging devices.

5. The apparatus of claim 4, wherein the multi-camera system further comprises a processor executing an artificial intelligence (AI) system that analysis the video footage in real-time to detect and identify one or more subjects of interest.

6. The apparatus of claim 1, further comprising:
a multi-axis gimbal system on which the multi-camera system is mounted,
wherein the multi-axis gimbal system is configured to stabilize the different imaging devices and maintain respective orientations of the different imaging devices.

7. The apparatus of claim 6, wherein the multi-axis gimbal system is configured to automatically maintain an upward-facing view for the different imaging devices.

8. The apparatus of claim 6, wherein the multi-axis gimbal system is configured to implement a scanning pattern for the different imaging devices.

9. The apparatus of claim 8, wherein the scanning pattern comprises a rosette scanning pattern.

10. The apparatus of claim 1, wherein the apparatus is portable and carriable by an individual user.

11. The apparatus of claim 1, wherein the apparatus provides ground-to-air aerial object detection.
